(19) United States
(12) Patent Application Publication
(10) Pub. No.: US 2017/0280636 A1
(43) Pub. Date: Oct. 5, 2017

(54) THERMOPLASTIC FILMS FOR PLASTICULTURE APPLICATIONS

(71) Applicant: SABIC GLOBAL TECHNOLOGIES B.V., Bergen op Zoom (NL)

(72) Inventors: Salaheldin M A. Habibi, Riyadh (SA); Akhlaq A. Moman, Riyadh (SA); Abdullah Shamroukh Al-Otaibi, Riyadh (SA)

(21) Appl. No.: 15/620,414

(22) Filed: Jun. 12, 2017

Related U.S. Application Data
(63) Continuation of application No. PCT/EP2015/078360, filed on Dec. 2, 2015.
(60) Provisional application No. 62/099,289, filed on Jan. 2, 2015.

(30) Foreign Application Priority Data
Dec. 12, 2014 (EP) 14197561.5

(51) Int. Cl. A01G 9/14; C08K 5/526; C08K 5/098; C08J 5/18; C08K 5/134

(52) U.S. Cl. CPC A01G 9/1438; C08J 5/18; C08K 5/134; C08K 5/098; C08K 5/526; C08J 2323/06

(57) ABSTRACT

The present invention relates to a film for use in plasticulture that comprises at least a first layer of a thermoplastic polymer composition, said thermoplastic polymer composition comprising a linear low-density polyethylene having a melt index (MI) measured according to ASTM D1238 at a temperature of 190° C. and a load of 2.16 kg of higher than 1.0 g/10 min and at most 10.0 g/10 min, whereby the film has an RMS roughness measured by AFM according to point 4.2.2 of ISO 4287:1997 of lower than 40 nm, and/or an average roughness measured by AFM according to point 4.2.1 of ISO 4287:1997 of lower than 30 nm.

The present invention relates to a film produced from a thermoplastic polymer composition comprising linear low-density polyethylene, also referred to as LLDPE, for use in plasticulture applications, in which the LLDPE is made using an Advanced Ziegler-Natta catalyst. The invention also relates to the use of said film as greenhouse cover, mulch film or agricultural film. The invention further relates to a greenhouse cover comprising said film, and a greenhouse comprising said greenhouse cover.

Linear low-density polyethylene films are used for a wide variety of applications. The LLDPE films according to the present invention are particularly suitable for use in plasticulture applications such as mulch films, agricultural films and greenhouse films.

With the global need for nutritional products ever increasing, optimization of production of nutritional products is an important area of technological development. In this area, one of the solutions that increasingly draws attention is plasticulture. Plasticulture is defined as the use of plastic film materials in horticulture, in order to further intensify the crop growth process. Various solutions exist in which plastic films are used, such as for mulch film, for row coverings, and high or low polytunnels. These polytunnels are tunnel-shaped greenhouse structures that are made using plastic film covers, which allows farmers to work on their crops underneath the polytunnel cover. Horticulture is defined as the branch of agriculture that deals with plant cultivation, including for example the cultivation of crops selected from one or more of fruits, vegetables, nuts, seeds, herbs, sprouts, mushrooms, algae, flowers, seaweeds and non-food crops such as grass and ornamental trees and plants.

Greenhouses are commonly used structures for ensuring a conditioned environment for horticulture. By creating favorable growth conditions tailored to crops, the quality, quantity and space-time yield in cultivation processes can for example be improved, compared to outdoor cultivation.

In order to increase the flexibility of land use, temporary greenhouses allow a unit of land to be cultivated under plasticulture for one or more seasons. This allows a farmer to be flexible in the choice of the type of crop to be cultivated on his area of land. Temporary greenhouses generally comprise a tent-shape structure that covers an area of land, commonly in the form of a tunnel shapet. Such tunnel-shaped greenhouses are referred to as polytunnels. The covers of these polytunnels are generally made of polymer films. Particularly useful polymer films are polyethylene films.

In order to provide the material quality at an economic scale, the films used to produce said polytunnels are defined by properties including for example optical properties such as for example haze, clarity and gloss, as well as for example mechanical properties such as for example tensile strength and tensile elongation, and for example film production properties such as for example the blow-up ratio and the output rate.

Linear low-density polyethylenes are well-known materials for production of films. Linear low-density polyethylenes are polyethylenes that comprise short branches introduced by copolymerization of ethylene with second α-olefin used as comonomer, said second α-olefin having from 3 to 20 carbon atoms. The said second α-olefin may be selected from for example propylene, 1-butene, 1-pentene, 1-hexene, 1-octene, 4-methyl-1-pentene, 1,3-butadiene, 1,4-pentadiene, 1,5-hexadiene and mixtures thereof. Preferably, 1-butene, 1-hexene and 1-octene are used as second α-olefin, and most preferably 1-butene. The amount of the comonomer needed depends for example on the desired product properties and specific comonomer used. The skilled person can easily select the suitable amount to obtain the desired product. In general, LLDPE is provided containing 0.01 to 30 wt. % of one or more comonomers and from 70 to 99.99 wt. % of ethylene units. The polymerization process for producing LLDPE commonly is a catalytic process, in which a heterogeneous catalyst is used. Common catalyst systems include Ziegler-Natta catalysts, Phillips-type chromium catalysts and single-site catalysts, also known as metallocene catalysts. LLDPE may be manufactured via slurry processes, solutions processes and gas-phase processes. Preferably, the density of the LLDPE ranges between 915 and 935 kg/m³. LLDPE materials and the production thereof are well known and are for example presented in ‘Polyethylene, linear low-density’, Y. Kissin, in ‘Kirk-Othmer Encyclopedia of Chemical Technology’, John Wiley & Sons, 2000.

Various polyethylene material solutions have been investigated and/or used in commercial settings. However, LDPE films lack good mechanical properties, while LLDPE lack good optical properties and have poor bubble stability in the production of film via blown film production.

A number of developments have been reported to overcome the problems associated with the use of either LDPE or LLDPE for plasticulture. For example in EP1961557, it is acknowledged that single-layer LDPE films lack the desired tear resistance, whereas single-layer films of a conventional Ziegler-Natta catalyzed LLDPE lack the desired optical properties, such as haze. In order to overcome these, the invention of EP1961557 relates to multi-layer systems comprising both an LLDPE and an LDPE layer.

The use of LLDPE for greenhouse films is described in a.o. CN102746563. However, the LLDPE in this publication is produced using a conventional Ziegler-Natta catalyst system, and the film produced with this material still shows a high haze. As a result of that, the LLDPE material described in CN102746563 does not qualify for use in applications according to the present invention where a low haze is desired.

It is therefore an object of the present invention to provide a linear low-density polyethylene film for plasticulture applications having a combination of good mechanical properties and good optical properties, which may be manufactured as a single-layer film.

In particular, it is an object of the present invention to provide a linear low-density polyethylene film for plasticulture applications where a high transmission of light is desired.

This objective is achieved according to the present invention by a film for use in plasticulture that comprises or consists of at least a first layer of a thermoplastic polymer composition, said thermoplastic polymer composition comprising a linear low-density polyethylene having a melt index (MI) measured according to ASTM D1238 at a temperature of 190° C. and a load of 2.16 kg of higher than 1.0 g/10 min and at most 10 g/10 min, whereby the film has an RMS roughness measured by AFM according to point 4.2.2 of ISO 4287:1997of lower than 40 nm, and/or an average roughness measured by AFM according to point 4.2.1 of ISO 4287:1997 of lower than 30 nm.

ISO 4287:1997 thereby relates to geometrical product specifications- Surface texture: Profile method. Atomic Force Microscopy (AFM) is thereby used for the measurements. The root mean square roughness (RMS roughness) can thereby be measured as described in point 4.2.2 of ISO 4287:1997 using AFM. The root mean square roughness (RMS roughness) can thus be the root mean square deviation of the assessed profile. The primary profile, the roughness profile or the waviness profile can be used therefore. However, preferably the primary profile can used for that. The average roughness can thereby be measured as described in point 4.2.1 of ISO 4287:1997 using AFM. The average roughness can thus be the arithmetical mean deviation of the assessed profile. The primary profile, the roughness profile or the waviness profile can be used therefore. However, preferably the primary profile can used for that. Measurements can preferably be done using AFM in tapping mode. An automatic plane fit and/or especially for example a “one dimensional bow removal” operation may be applied before the roughness measurements. Sampling length for the profile can preferably for example be 1 μm, 5 μm or 20 μm, preferably with for example 256 data points per line. The values for root mean square roughness (RMS roughness) and/or average roughness may also for example be averages of several measurements. Values for average roughness and/or RMS roughness can thereby for example be related to the morphology of the film, especially for example on the surface structure/texture and/or on to the size and/or form of crystalline and/or amorphous domains. The morphology of the film can thereby have an effect on the films properties. Film morphology can in turn especially for example be influenced by the nature of the catalyst used to produce the material of films. The inventors have thereby found that films with values according to the present invention for RMS roughness and/or average roughness may for example have improved/good optical and/or good mechanical properties that makes them particularly suitable for plasticulture applications.

In an preferred embodiment, the film for use in plasticulture according to the invention comprises at least a first layer of a thermoplastic polymer composition, said thermoplastic polymer composition comprising a linear low-density polyethylene in which said linear low-density polyethylene is obtained by a process for producing a copolymer of ethylene and an second a-olefin comonomer in the presence of an Advanced Ziegler-Natta catalyst, wherein the Advanced Ziegler-Natta catalyst is produced in a process comprising the steps of:
(a) contacting a dehydrated support having hydroxyl groups with a magnesium compound having the general formula MgR¹R², wherein R¹ and R²are the same or different and are independently selected from the group comprising an alkyl group, alkenyl group, alkadienyl group, aryl group, alkaryl group, alkenylaryl group and alkadienylaryl group;
(b) contacting the product obtained in step (a) with modifying compounds (A), (B) and (C), wherein:
   compound (A) is at least one compound selected from the group consisting of carboxylic acid, carboxylic acid ester, ketone, acyl halide, aldehyde and alcohol;
   compound (B) is a compound having the general formula R¹¹_{f}(R¹²O)_{g}SiXₕ, wherein f, g and h are each integers from 0 to 4 and the sum of f, g and h is equal to 4, Si is a silicon atom, O is an oxygen atom, X is a halide atom and R¹¹ and R¹² are the same or different and are independently selected from the group comprising an alkyl group, alkenyl group, alkadienyl group, aryl group, alkaryl group, alkenylaryl group and alkadienylaryl group, with a proviso that when h is equal to 4 then modifying compound (A) is not an alcohol;
   compound (C) is a compound having the general formula (R¹³O)4M, wherein M is a titanium atom, a zirconium atom or a vanadium atom, O is an oxygen atom and R¹³ is selected from the group comprising an alkyl group, alkenyl group, alkadienyl group, aryl group, alkaryl group, alkenylaryl group and alkadienylaryl group; and
(c) contacting the product obtained in step (b) with a titanium halide compound having the general formula TiX₄, wherein Ti is a titanium atom and X is a halide atom,

that may further have has an RMS roughness measured by AFM according to point 4.2.2 ISO 4287:1997of lower than 40 nm, and/or an average roughness measured by AFM according to point 4.2.1 of ISO 4287:1997 of lower than 30 nm.

In a preferred embodiment, said RMS roughness measured according to point 4.2.2 of ISO 4287:1997 samples may be for example lower than 39 nm, more preferably lower than 38 nm, more preferably lower than 37 nm, more preferably lower than 36 nm, more preferably lower than 35 nm, more preferably lower than 34 nm, more preferably lower than 33 nm, more preferably lower than 32 nm, more preferably lower than 31 nm, more preferably lower than 30 nm, more preferably lower than 29 nm, more preferably lower than 28 nm, more preferably lower than 27 nm, more preferably lower than 26 nm, more preferably lower than 25 nm, more preferably lower than 24 nm, more preferably lower than 23 nm, more preferably lower than 22 nm, more preferably lower than 21 nm, more preferably lower than 20 nm, more preferably lower than 19 nm, more preferably lower than 18 nm, more preferably lower than 17 nm, more preferably lower than 16 nm, more preferably lower than 15 nm, more preferably lower than 14 nm, more preferably lower than 13 nm, more preferably lower than 12 nm, more preferably lower than 11 nm, more preferably lower than 10 nm.

In another preferred embodiment, said average roughness measured according to point 4.2.1 of ISO 4287:1997 may be for example lower than 29 nm, more preferably lower than 28 nm, more preferably lower than 27 nm, more preferably lower than 26 nm, more preferably lower than 25 nm, more preferably lower than 24 nm, more preferably lower than 23 nm, more preferably lower than 22 nm, more preferably lower than 21 nm, more preferably lower than 20 nm, more preferably lower than 19 nm, more preferably lower than 18 nm, more preferably lower than 17 nm, more preferably lower than 16 nm, more preferably lower than 15 nm, more preferably lower than 14 nm, more preferably lower than 13 nm, more preferably lower than 12 nm, more preferably lower than 11 nm, more preferably lower than 10 nm.

Film roughness could for example be related to light transmission, whereby a roughness according to the present invention can for example contribute to an improved the light transmission of LLDPE films according to the invention.

In a preferred embodiment, said second α-olefin comonomer is selected from propylene, 1-butene, 1-pentene, 1-hexene, 1-octene, 4-methyl-1-pentene, 1,3-butadiene, 1,4-pentadiene, 1,5-hexadiene and mixtures thereof.

In another preferred embodiment, said support for said Advanced Ziegler Natta catalyst is selected from silica, alumina, magnesia, thoria, zirconia or mixtures thereof.

In yet another preferred embodiment, said compound (A) is selected from methyl-n-propyl ketone, ethyl acetate, n-butyl acetate, acetic acid, isobutyric acid, isobutyraldehyde, ethanoyl chloride, ethanol or sec-butanol.

In yet another preferred embodiment, said compound (B) is selected from tetraethoxysilane, n-propyltriethoxysilane, isobutyltrimethoxysilane, dimethyldichlorosilane, n-butyltrichlorosilane or silicon tetrachloride.

In yet another preferred embodiment, said compound (C) is selected from titanium tetraethoxide, titanium tetra-n-butoxide or zirconium tetra-n-butoxide.

In yet another preferred embodiment, said TiX₄ is TiCl₄.

One of the factors that has an influence on growth conditions is the radiation which is allowed to pass through the greenhouse film. In order to control the transparency to specific wavelength of radiation, the film may comprise additives with a specific radiation absorbing function. Depending on the type of crop to be cultivated, the thermoplastic polymer composition that is used to produce the film according to the present invention may comprise such additives. Radiation absorbing additives that may be used are for example ultra-violet absorbing additives (UV absorbing additives) and near infra-red absorbing additives (NIR absorbing additives). The object is to maximize the transmission of radiation in the bandwidth range that is important for crop growth, which is known as the photo-active region or PAR, and minimize the transmission of radiation of higher or lower bandwidth than PAR. The bandwidth range of PAR is between 400 and 700 nm.

To absorb the radiation in wavelengths above PAR, the thermoplastic polymer composition that is used to produce the film according to the present invention may comprise NIR absorbing additives. This is in particular needed for films applied in arid regions, where the quantity of NIR radiation in the incident radiation is relatively large. This may lead to excessive temperature build-up in the greenhouse, as well as evaporation of water which is important for crop nutrition from the soil. NIR absorbing additives typically absorb radiation in the bandwidth area of 700-1500 nm.

To absorb the radiation in wavelengths below PAR, the thermoplastic polymer composition that is used to produce the film according to the present invention may comprise UV absorbing additives.

In a preferred embodiment, said the thermoplastic composition is optimized to prevent absorption of radiation in the photo-active region by addition of absorbing additives.

In another preferred embodiment, said absorbing additives are selected from NIR absorbing additives and/or UV absorbing additives.

In a further preferred embodiment, said thermoplastic polymer composition may comprise a NIR absorbing additive.

Preferably, said NIR absorbing additive is one or more selected from organic or inorganic NIR absorbers, or combinations thereof. Said organic NIR absorber may be one or more selected from phtalocyanines, naphthalocyanines, azo dyes, anthraquinones, immonium dyes, perylenes, quarterylenes and polymethines. Preferably, said organic NIR absorber may be present in for example an amount of 1 to 10.000 ppm, preferably 1 to 1000 ppm, more preferably 20 to 400 ppm, relative to the total weight of the thermoplastic composition.

Said inorganic NIR absorber can be one or more selected from tin oxides, modified tin oxides, zinc oxides, modified zinc oxides, and borides. Preferably, the average particle size of said inorganic NIR absorber is for example less than 200 nm, more preferably between 20 and 200 nm. Preferably, said inorganic NIR absorber may be present in an amount of for example 0.02 ppm to 3000 ppm, more preferably 1 ppm to 1500 ppm, even more preferably 2.5 ppm to 600 ppm, relative to the total weight of the thermoplastic composition.

In a further preferred embodiment, said thermoplastic polymer composition may comprise a UV absorbing additive.

In a further preferred embodiment, said UV absorbing additive is one or more selected from benzophenones, benzotriazoles and salicylates, or combinations thereof.

The UV absorbers may be present in amounts of 1 to 15 wt %, preferably 2 to 12 wt %, more preferably 3 to 11 wt %, even more preferably 4 to 10 wt %, even more preferably 5 to 8 wt %, relative to the total weight of the thermoplastic polymer composition. Such amounts provide sufficient capacity to prevent the undesired UV radiation from passing through the film.

The film according to the present invention preferably is a single-layer film.

The present invention also concerns the use of film according to the present invention as agricultural film, especially for example for application where a high light transmission is desired, like for example application as plant covers, covers/elements for polytunnels/greenhouses. The present invention thus further also concerns a greenhouse cover, especially a polytunnel cover, comprising a film according to the present invention.

The LLDPE polymer that is obtainable by a process for producing a copolymer of ethylene and another α-olefin, especially in the presence of the AZ catalyst can be referred to as AZ LLDPE.

### LLDPE

The polyethylene composition according to the invention can for example comprise and/or consist of a linear low-density polyethylene (LLDPE), preferably an AZ LLDPE. AZ LLDPE can thereby be obtained by a process for producing an ethylene and another a-olefin in the presence of an Advanced Ziegler-Natta catalyst (AZ catalyst).

### Process for Producing an AZ Catalyst

The Advanced Ziegler-Natta catalyst is produced in a process comprising a first step (a) of contacting a dehydrated solid support having hydroxyl (OH) groups with a magnesium compound to form a solid magnesium containing support material.

The solid support is any material containing hydroxyl groups. Suitable examples of such materials include inorganic oxides, such as silica, alumina, magnesia, thoria, zirconia and mixtures of such oxides. Preferably, porous silica is used as the support as higher bulk densities and higher catalyst productivities are obtained therewith. Silica may be in the form of particles having a mean particle diameter of 1 micron to 500 microns, preferably from 5 microns to 150 microns and most preferably from 10 microns to 100 microns. Silica with a lower mean particle diameter may produce a higher level of polymer fines and silica with a higher mean particle diameter may reduce polymer bulk density. The silica may have a surface area of 5 m²/g to 1500 m²/g, preferably from 50 m²/g to 1000 m²/g and a pore volume of from 0.1 cm³/g to 10.0 cm³/g, preferably from 0.3 cm³/g to 3.5 cm³/g, as higher catalyst productivity is obtained in this range.

The dehydrated solid support can be obtained by drying the solid support in order to remove physically bound water and to reduce the content of hydroxyl groups to a level which may be of from 0.1 mmol to 5.0 mmol hydroxyl groups per gram of support, preferably from 0.2 mmol to 2.0 mmol hydroxyl groups per gram of support, as this range allows sufficient incorporation of the active catalyst components to the support, determined by the method as described in J. J. Fripiat and J. Uytterhoeven, J. Phys. Chem. 66, 800, 1962 or by applying ¹H NMR spectroscopy. The hydroxyl group content in this range may be achieved by heating and fluidizing the support at a temperature of from 150° C. to 900° C. for a time of 1 hour to 15 hours under a nitrogen or air flow. The dehydrated support can be slurried, preferably by stirring, in a suitable hydrocarbon solvent in which the individual catalyst components are at least partially soluble. Examples of suitable hydrocarbon solvents include n-pentane, isopentane, cyclopentane, n-hexane, isohexane, cyclohexane, n-heptane, isoheptane, n-octane, isooctane and n-decane. The amount of solvent used is not critical, though the solvent should be used in an amount to provide good mixing of the catalyst components.

The magnesium compound is represented by the general formula MgR¹R², wherein R¹ and R² are the same or different and are independently selected from a group comprising an alkyl group, alkenyl group, alkadienyl group, aryl group, alkaryl group, alkenylaryl group and an alkadienylaryl group and may have from 1 to 20 carbon atoms. Suitable examples of the magnesium compound include dimethylmagnesium, diethylmagnesium, ethylmethylmagnesium, di-n-propylmagnesium, diisopropylmagnesium, n-propylethylmagnesium, isopropylethylmagnesium, di-n-butylmagnesium, diisobutylmagnesium, n-butylethylmagnesium, n-butyl-n-propylmagnesium, n-butylisopropylmagnesium, isobutylethylmagnesium, isobutyl-n-propylmagnesium, isobutylisopropylmagnesium, di-n-pentylmagnesium, diisopentylmagnesium, n-pentylethylmagnesium, n-pentyl-n-propylmagnesium, n-pentylisopropylmagnesium, n-pentyl-n-butylmagnesium, n-pentylisobutylmagnesium, di-n-hexylmagnesium, diisohexylmagnesium, n-hexylethylmagnesium, n-hexyl-n-propylmagnesium, n-hexylisopropyl magnesium, n-hexyl-n-butylmagnesium, n-hexylisobutylmagnesium, isohexylethylmagnesium, isohexyl-n-propylmagnesium, isohexylisopropyl magnesium, isohexyl-n-butylmagnesium, isohexylisobutylmagnesium, di-n-octylmagnesium, diisooctylmagnesium, n-octylethylmagnesium, n-octyl-n-propylmagnesium, n-octylisopropylmagnesium, n-octyl-n-butylmagnesium, n-octylisobutyl magnesium, isooctylethylmagnesium, isooctyl-n-propylmagnesium, isooctylisopropylmagnesium, isooctyl-n-butylmagnesium, isooctylisobutyl magnesium, dicyclopentylmagnesium, cyclopentylethylmagnesium, cyclopentyl-n-propylmagnesium, cyclopentylisopropylmagnesium, cyclopentyl-n-butylmagnesium, cyclopentylisobutylmagnesium, dicyclohexylmagnesium, cyclohexylethylmagnesium, cyclohexyl-n-propylmagnesium, cyclohexylisopropyl magnesium, cyclohexyl-n-butylmagnesium, cyclohexylisobutylmagnesium, diphenylmagnesium, phenylethylmagnesium, phenyl-n-propylmagnesium, phenyl-n-butylmagnesium and mixtures thereof.

Preferably, the magnesium compound is selected from the group comprising di-n-butylmagnesium, n-butylethylmagnesium and n-octyl-n-butylmagnesium.

The magnesium compound can be used in an amount ranging from 0.01 to 10.0 mmol per gram of solid support, preferably from 0.1 to 3.5 mmol per gram of support and more preferably from 0.3 to 2.5 mmol per gram of support as by applying this range the level of polymer fines of the product is reduced and higher catalyst productivity is obtained. The magnesium compound may be reacted, preferably by stirring, with the support at a temperature of 15° C. to 140° C. during 5 minutes to 150 minutes, preferably at a temperature of 20° C. to 80° C. for a duration of 10 minutes to 100 minutes.

The molar ratio of Mg to OH groups in the solid support can be in the range of 0.01 to 10.0, preferably of from 0.1 to 5.0 and more preferably of from 0.1 to 3.5, as the level of polymer fines of the product is reduced and higher catalyst productivity is obtained. The modifying compound (A) is at least one compound selected from the group consisting of carboxylic acids, carboxylic acid esters, ketones, acyl halides, aldehydes and alcohols. The modifying compound (A) may be represented by the general formula R³COOH, R⁴COOR⁵, R⁶COR⁷, R⁸COX, R⁹COH or R¹⁰OH, wherein X is a halide atom and R³, R⁴, R⁵, R⁶, R⁷, R⁸, R⁹ and R¹⁰ are independently selected from a group of compounds comprising an alkyl group, alkenyl group, alkadienyl group, aryl group, alkaryl group, alkenylaryl group and an alkadienylaryl group and may have from 1 to 20 carbon atoms.

Suitable examples of the carboxylic acids include acetic acid, propionic acid, isopropionic acid, butyric acid, isobutyric acid, valeric acid, isovaleric acid, caproic acid, isocaproic acid, enanthic acid, isoenanthic acid, caprylic acid, isocaprylic acid, pelargonic acid, isopelargonic acid, capric acid, isocapric acid, cyclopentanecarboxylic acid, benzoic acid and mixtures thereof.

Suitable examples of carboxylic acid esters include methyl acetate, ethyl acetate, n-propyl acetate, isopropyl acetate, n-butyl acetate, isobutyl acetate, isoamyl acetate, ethyl butyrate, n-butyl butyrate and/or isobutyl butyrate.

Suitable examples of ketones include dimethyl ketone, diethyl ketone, methyl ethyl ketone, di-n-propyl ketone, di-n-butyl ketone, methyl n-propyl ketone, methyl isobutyl ketone, cyclohexanone, methyl phenyl ketone, ethyl phenyl ketone, n-propyl phenyl ketone, n-butyl phenyl ketone, isobutyl phenyl ketone, diphenyl ketone and mixtures thereof.

Suitable examples of acyl halides include ethanoyl chloride, propanoyl chloride, isopropanoyl chloride, n-butanoyl chloride, isobutanoyl chloride, benzoyl chloride and mixtures thereof.

Suitable examples of aldehydes include acetaldehyde, propionaldehyde, n-butyraldehyde, isobutyraldehyde, n-pentanaldehyde, isopentanaldehyde, n-hexanaldehyde, isohexanaldehyde, n-heptanaldehyde, benzaldehyde and mixtures thereof.

Suitable examples of alcohols include methanol, ethanol, n-propanol, isopropanol, n-butanol, isobutanol, sec-butanol, tert-butanol, cyclobutanol, n-pentanol, isopentanol, cyclopentanol, n-hexanol, isohexanol, cyclohexanol, n-octanol, isooctanol, 2-ethylhexanol, phenol, cresol, ethylene glycol, propylene glycol and mixtures thereof.

Preferably, the modifying compound (A) is at least one compound selected from the group comprising methyl n-propyl ketone, ethyl acetate, n-butyl acetate, acetic acid, isobutyric acid, isobutyraldehyde, ethanoyl chloride, ethanol and sec-butanol, and more preferably from methyl n-propyl ketone, n-butyl acetate, isobutyric acid and ethanoyl chloride as higher catalyst productivity and higher bulk density of the products are obtained and these compounds can be used to vary molecular weight distribution of the product.

The molar ratio of modifying compound (A) to magnesium in the solid support can be in a range of from 0.01 to 10.0, preferably of from 0.1 to 5.0, more preferably of from 0.1 to 3.5 and most preferably of from 0.3 to 2.5, as higher catalyst productivity and higher bulk density of the products are obtained. The modifying compound (A) may be added to the reaction product obtained in step (a), preferably by stirring, at a temperature of 15° C. to 140° C. for a duration of 5 minutes to 150 minutes, preferably at a temperature of 20° C. to 80° C. for a duration of 10 minutes to 100 minutes.

The modifying compound (B) is a silicon compound represented by the general formula R¹¹_{f}(R¹²O)_{g}SiXₕ, wherein f, g and h are each integers from 0 to 4 and the sum of a, b and c is equal to 4, Si is a silicon atom, O is an oxygen atom, X is a halide atom and R¹¹ and R¹² are the same or different, with a proviso that when c is equal to 4 then modifying compound (A) is not an alcohol. R¹¹ and R¹² are independently selected from the group of compounds comprising an alkyl group, alkenyl group, alkadienyl group, aryl group, alkaryl group, alkenylaryl group and an alkadienylaryl group. R¹¹ and R¹² may have from 1 to 20 carbon atoms.

Suitable silicon compounds include tetramethoxysilane, tetraethoxysilane, tetra-n-propoxysilane, tetraisopropoxysilane, tetra-n-butoxysilane, tetraisobutoxysilane, methyltrimethoxysilane, ethyltrimethoxysilane, n-propyltrinnethoxysilane, isopropyltrimethoxysilane, n-butyltrimethoxysilane, isobutyltrimethoxysilane, n-pentyltrimethoxysilane, n-hexyltrimethoxysilane, n-octyltrimethoxysilane, isooctyltrimethoxysilane, vinyltrinnethoxysilane, phenyltrimethoxysilane, dimethyldimethoxysilane, diethyldimethoxysilane, isobutylmethyldimethoxysilane, diisopropyldimethoxysilane, diisobutyldimethoxysilane, isobutylisopropyldimethoxysilane, dicyclopentyldimethoxysilane, cyclohexylnnethyldinnethoxysilane, phenylmethyldimethoxysilane, diphenyldimethoxysilane, trimethylmethoxysilane, triethylmethoxysilane, methyltriethoxysilane, ethyltriethoxysilane, n-propyltriethoxysilane, isopropyltriethoxysilane, n-butyltriethoxysilane, isobutyltriethoxysilane, n-pentyltriethoxysilane, n-hexyltriethoxysilane, n-octyltriethoxysilane, isooctyltriethoxysilane, vinyltriethoxysilane, phenyltriethoxysilane, dimethyldiethoxysilane, diethyldiethoxysilane, isobutylmethyldiethoxysilane, diisopropyldiethoxysilane, diisobutyldiethoxysilane, isobutylisopropyldiethoxy silane, dicyclopentyldiethoxysilane, cyclohexylmethyldiethoxysilane, phenyl methyldiethoxysilane, diphenyldiethoxysilane, trimethylethoxysilane, triethylethoxysilane, silicon tetrachloride, methyltrichlorosilane, ethyltrichlorosilane, n-propyltrichlorosilane, isopropyltrichlorosilane, n-butyltrichlorosilane, isobutyltrichlorosilane, n-pentyltrichlorosilane, n-hexyltrichlorosilane, n-octyltrichlorosilane, isooctyltrichlorosilane, vinyl ltrichlorosilane, phenyltrichlorosilane, dimethyldichlorosilane, diethyl dichlorosilane, isobutylmethyldichlorosilane, diisopropyldichlorosilane, diisobutyldichlorosilane, isobutylisopropyldichlorosilane, dicyclopentyldichloro silane, cyclohexylmethyldichlorosilane, phenylmethyldichlorosilane, diphenyldichlorosilane, trimethylchlorosilane, triethylchlorosilane, chloro trimethoxysilane, dichlorodimethoxysilane, trichloronnethoxysilane, chloro triethoxysilane, dichlorodiethoxysilane and/or trichloroethoxysilane. Preferably, the modifying compound (B) used is tetraethoxysilane, n-propyltriethoxysilane, isobutyltrimethoxysilane, dimethyldichlorosilane, n-butyltrichlorosilane and silicon tetrachloride, and more preferably isobutyltrimethoxysilane, tetraethoxysilane, n-propyltriethoxysilane, n-butyltrichlorosilane and and silicon tetrachloride as higher catalyst productivity and higher bulk density are obtained with the ability to vary the molecular weight distribution of the product by employing these preferred compounds.

The molar ratio of modifying compound (B) to magnesium may be in a range of from 0.01 to 5.0, preferably from 0.01 to 3.0, more preferably from 0.01 to 1.0 and most preferably from 0.01 to 0.3, as higher catalyst productivity and higher bulk density are obtained. The modifying compound (B) may be added to the reaction product obtained in step (a), preferably by stirring, at a temperature of 15° C. to 140° C. during 5 minutes to 150 minutes, preferably at a temperature of 20° C. to 80° C. during 10 minutes to 100 minutes.

The modifying compound (C) is a transition metal alkoxide represented by the general formula (R¹³O)₄M, wherein M is a titanium atom, a zirconium atom or a vanadium atom, O is an oxygen atom and R¹³ is a compound selected from the group of compounds comprising an alkyl group, alkenyl group, alkadienyl group, aryl group, alkaryl group, alkenylaryl group and an alkadienylaryl group. R¹³ may have from 1 to 20 carbon atoms.

Suitable transition metal alkoxide compounds include titanium tetramethoxide, titanium tetraethoxide, titanium tetra-n-propoxide, titanium tetraisopropoxide, titanium tetra-n-butoxide, titanium tetraisobutoxide, titanium tetra-n-pentoxide, titanium tetraisopentoxide, titanium tetra-n-hexoxide, titanium tetra-n-heptoxide, titanium tetra-n-octoxide, titanium tetracyclohexoxide, titanium tetrabenzoxide, titanium tetraphenoxide, zirconium tetramethoxide, zirconium tetraethoxide, zirconium tetra-n-propoxide, zirconium tetraisopropoxide, zirconium tetra-n-butoxide, zirconium tetraisobutoxide, zirconium tetra-n-pentoxide, zirconium tetraisopentoxide, zirconium tetra-n-hexoxide, zirconium tetra-n-heptoxide, zirconium tetra-n-octoxide, zirconium tetracyclohexoxide, zirconium tetrabenzoxide, zirconium tetraphenoxide, vanadium tetramethoxide, vanadium tetraethoxide, vanadium tetra-n-propoxide, vanadium tetraisopropoxide, vanadium tetra-n-butoxide, vanadium tetraisobutoxide, vanadium tetra-n-pentoxide, vanadium tetraisopentoxide, vanadium tetra-n-hexoxide, vanadium tetra-n-heptoxide, vanadium tetra-n-octoxide, vanadium tetracyclohexoxide, vanadium tetrabenzoxide, vanadium tetraphenoxide or mixtures thereof. Preferably, titanium tetraethoxide, titanium tetra-n-butoxide and zirconium tetra-n-butoxide are used because higher catalyst productivity and higher bulk density are obtained with the ability to vary the molecular weight distribution of the product by employing these preferred compounds.

The molar ratio of the modifying compound (C) to magnesium may be in the range of from 0.01 to 5.0, preferably from 0.01 to 3.0, more preferably from 0.01 to 1.0 and most preferably from 0.01 to 0.3, as higher catalyst productivity, higher bulk density and improved hydrogen response in polymerization are obtained. The modifying compound (C) may be reacted, preferably by stirring, with the product obtained in step (a) at a temperature of 15° C. to 140° C. for a duration of 5 minutes to 150 minutes, preferably at a temperature of 20° C. to 80° C. for a duration of 10 minutes to 100 minutes.

The modifying compounds (A), (B) and (C) can be contacted in any order or simultaneously with the solid magnesium containing support obtained in step (a). Pre-mixtures of the individual catalyst components can also be utilized. Preferably, (A) is added first to the reaction product obtained in step (a) and then (B), followed by the addition of (C) as higher catalyst productivity and higher product bulk density are obtained by employing this order of adding the modifying compounds.

Preferably, when modifying compound (A) is methyl n-propyl ketone and modifying compound (C) is titanium tetraethoxide, a further increase of molecular weight distribution is obtained when modifying compound (B) is selected in the following order from the group consisting of isobutyltrimethoxysilane, n-propyltriethoxysilane, tetraethoxysilane, n-butyltrichlorosilane and silicon tetrachloride, at the same levels of titanium halide compound.

In the preferred case when the modifying compound (B) is silicon tetrachloride and modifying compound (C) is titanium tetraethoxide, a further improved combination of catalyst productivity and bulk density is obtained when modifying compound (A) is selected in the following order from the group consisting of isobutyraldehyde, ethyl acetate, n-butyl acetate, methyl n-propyl ketone and isobutyric acid, at the same levels of titanium halide compound.

The titanium halide compound is represented by the general formula TiX₄, wherein Ti is a titanium atom and X is a halide atom.

Suitable titanium halide compounds include titanium tetrachloride, titanium tetrabromide, titanium tetrafluoride or mixtures thereof. The preferred titanium halide compound is titanium tetrachloride, as higher catalyst productivity is obtained. The molar ratio of the titanium halide compound to magnesium may be in the range of 0.01 to 10.0, preferably from 0.01 to 5.0 and more preferably from 0.05 to 1.0, as a better balance of high catalyst productivity and high bulk density is obtained.

The titanium halide compound may be added to the reaction mixture obtained by applying step (a) and step (b) in any conventional manner, such as by stirring, at a temperature of 15° C. to 140° C. for a duration of 5 minutes to 150 minutes , preferably at a temperature of 20° C. to 80° C. for a duration of 10 minutes to 100 minutes. The reaction mixture may be then dried using a nitrogen purge and/or by vacuum at a temperature from 15° C. to 140° C. preferably 30° C. to 100° C. and most preferably 50° C. to 80° C. to yield the Advanced Ziegler-Natta catalyst component.

The total molar ratio of the modifying compound (C) and the titanium halide compound to magnesium may be in the range of from 0.01 to 10.0, preferably of from 0.01 to 5.0 and more preferably of from 0.05 to 1.0, as a better balance of high catalyst productivity and high bulk density is obtained.

The total molar ratio of the modifying compound (C) and the titanium halide compound to hydroxyl (OH) groups in the support after dehydration may be in the range of from 0.01 to 10.0, preferably of from 0.01 to 5.0 and more preferably of from 0.05 to 1.0, as a better balance of high catalyst productivity and high bulk density is obtained. Higher levels may results in high catalyst productivity though with reduced bulk density, especially in for example a gas phase polymerization processes. Further, applying these amounts eliminates the requirement to conduct solvent decanting, solvent filtering, solvent washing steps in catalyst preparation and hence eliminates generation of highly hazardous solvent waste material.

In one embodiment the Advanced Ziegler-Natta catalyst system can comprise a catalyst component and a co-catalyst. The co-catalyst is typically an organometallic compound such as aluminum alkyls, aluminum alkyl hydrides, lithium aluminum alkyls, zinc alkyls, calcium alkyls, magnesium alkyls or mixtures thereof. Preferred co-catalysts are represented by the general formula R¹²ₙAlY³₃₋ₙ, wherein Y³ represents a halide atom; n represents an integer from 0 to 3; and R¹² is selected from a group of compounds comprising an alkyl group, alkenyl group, alkadienyl group, aryl group, alkaryl group, alkenylaryl group and alkadienylaryl group. R¹² may have from 1 to 20 carbon atoms. Suitable examples of the cocatalyst include trimethylaluminum, triethylaluminum, tri-isobutylaluminum, tri-n-hexylaluminum, tri-n-octylaluminum, diethylaluminum chloride, diisobutylalumium chloride, ethylaluminium dichloride, isobutyl aluminum dichloride and mixtures thereof. Preferably, the cocatalyst is trimethylaluminum, triethylaluminum and/or tri-isobutylaluminum; and more preferably, the cocatalyst is triethylaluminum.

The cocatalyst may be used in a molar ratio of aluminum in the co-catalyst to titanium in the solid catalyst component of from 1 to 500, more preferably from 10 to 250, as high catalyst productivity is obtained.

### Process for Producing AZ LLDPE

The Advanced Ziegler-Natta catalyst system can be applied in slurry, gas or solution phase processes to obtain AZ LLDPE. Examples of such processes have already been described in the prior art and are thus well-known to the skilled person. Preferably, ethylene copolymers are produced by gas phase processes, such as stirred bed reactors and fluidized bed reactors or by slurry phase processes under polymerisation conditions already known in the art. Illustrative of gas phase processes are those disclosed for example in U.S. Pat. No. 4,302,565 and U.S. Pat. No. 4,302,566. A suitable example is a gas phase fluidized bed polymerization reactor fed by a dry or slurry catalyst feeder. The Advanced Ziegler-Natta catalyst may be introduced to the reactor in a site within the reaction zone to control the reactor production rate. The reactive gases, including ethylene and other alpha-olefins, hydrogen and nitrogen may be introduced to the reactor. The produced polymer may be discharged from the reaction zone through a discharge system. The bed of polymer particles in the reaction zone may be kept in fluidized state by a recycle stream that works as a fluidizing medium as well as to dissipate exothermal heat generated within the reaction zone. The reaction and compression heats can be removed from the recycle stream in an external heat exchange system in order to control the reactor temperature. Other means of heat removal from within the reactor can also be utilized, for example by the cooling resulting from vaporization of hydrocarbons such as isopentane, n-hexane or isohexane within the reactor. These hydrocarbons can be fed to the reactor as part of component reactant feeds and/or separately to the reactor to improve heat removal capacity from the reactor. The gas composition in the reactor can be kept constant to yield a polymer with the required specifications by feeding for example the reactive g gases, hydrogen and/or nitrogen to make-up the composition of the recycle stream.

Suitable operating conditions for the gas phase fluidized bed reactor typically include temperatures in the range of 50° C. to 115° C., more preferably from 70° C. to 110° C., an ethylene partial pressure from 3 bar to 15 bar, more preferably from 5 bar to 10 bar and a total reactor pressure from 10 bar to 40 bar, more preferably from 15 bar to 30 bar. The superficial velocity of the gas, resulting from the flow rate of recycle stream within reactor may be from 0.2 m/s to 1.2 m/s, more preferably 0.2 m/s to 0.9 m/s.

By applying the process and the Advanced Ziegler-Natta catalyst system AZ LLDPE can be produced. Suitable examples of AZ LLDPE may include ethylene copolymers with an alpha-olefin or di-olefin co-monomers, having from 3 to 20 carbon atoms, such as propylene, 1-butene, 1-pentene, 1-hexene, 1-octene, 4-methyl-1-pentene, 1,3-butadiene, 1,4-pentadiene, 1,5-hexadiene and mixtures thereof. Preferably, 1-butene, 1-hexene and 1-octene are used as co-monomers, and most preferably 1-butene. The amount of the comonomer needed depends generally on the desired product properties and specific comonomer used. The skilled person can easily select the required amount to obtain the desired product. In general, AZ LLDPE is provided containing 0.01 to 30 wt. % of one or more comonomers and from 70 to 99.99 wt. % of ethylene units.

Films according to the present invention can comprise and/or consist of a linear low-density polyethylene (LLDPE) with a melt index (MI) of for example between >1 g/10 min and 10 g/10 min, more preferably between 1.2 g/10 min and 7 g/10 min, more preferably between 1.3 g/10 min and 6 g/10 min , more preferably between 1.4 g/10 min and 5 g/10 min, more preferably between 1.5 g/10 min and 4 g/10 min, more preferably between 1.6 g/10 min and 3 g/10 min (measured according to ASTM D1238 at a temperature of 1900 and a load of 2.16 kg).

An AZ LLDPE with a melt index (MI) of at least for example 1.2 g/10 min, more preferably 1.5 g/10 min, more preferably 2.0 g/10 min, more preferably 2.5 g/10 min, and at most for example 10 g/10 min, more preferably 8.0 g/10 min, more preferably 6.0 g/10 min, more preferably 5.0 g/10 min, more preferably 4.0 g/10 min, more preferably 3.0 g/10 min, more preferably 2.5 g/10 min, more preferably 2.0 g/10 min (measured according to ASTM D1238 at a temperature of 1900 and a load of 2.16 kg) can be obtained by using the Advanced Ziegler-Natta catalyst by varying the hydrogen to ethylene molar ratio; increasing the hydrogen to ethylene molar ratio generally leads to an increase in the melt index. Also, the melt index of the polymers can be varied by controlling the polymerization temperature and the density of the polymer obtained. A polymer density of for example at least 850 kg/m³, alternatively at least 880 kg/m³, alternatively at least 910 kg/m³, alternatively at least 915 kg/m³, and for example at most 935 kg/m³, alternatively for example at most 930 kg/m³, can be obtained by using the Advanced Ziegler-Natta catalyst and by varying the comonomer to ethylene molar ratio; for instance, increasing the comonomer to ethylene molar ratio typically leads to a reduction in density. Lower ratios of hydrogen to ethylene and lower ratios of comonomer to ethylene can be used to attain the target melt index and target polymer density, respectively, reducing the cost requirement of the utilisation of hydrogen and comonomer.

### Production of Polyethylene Films

The production of films from polyethylene compositions most commonly can take place by one of two principle processes: blown film production or cast film production. Both processes are known in the art and described in e.g. the Handbook of Plastic Films, E. M Abdel-Bary (ed.), Rapra Technology Ltd., 2003, in sections 2.3 and 2.4. The film according to the present invention may be produced via either blown film production or cast film production. Preferably, the film according to the present invention is produced via blown film production.

Films according to the invention can be made for example with a Battenfeld machine using a temperature profile of for example 100° C. t o 300° C., preferably 120° C. to 275° C. further preferred 150° C. to 250° C. further preferred 175° C. to 225° C. even further preferred 190° C. to 200° C. Moreover, films according to the invention can be made for example with a Battenfeld machine using a die gap of for example 0.1 mm to 7 mm, preferably, 0.5 mm to 5 mm, further preferred 0.75 mm to 4 mm, further preferred 1 mm to 3 mm. Furthermore, films according to the invention can be made for example with a Battenfeld machine with a frost line height of for example 10 cm to 90 cm, preferably 15 cm to 80 cm, further preferred 20 cm to 70 cm, further preferred 25 cm to 60 cm, further preferred 30 cm to 50 cm. In addition, films according to the invention can be made for example with a Battenfeld machine with a blow-up ratio of for example 1.2:1 to 5:1, preferably 1.5 to 4, further preferred 2:1 to 3:1.

A parameter used in the production of films from polyethylene compositions via blown film production is the bubble stability. In particular, this can become important for example when the film is produced at high blow-up ratio (BUR). The BUR is defined as the ration between the diameter of the circular die opening of the blown film extruder and the diameter of the tubular film that is produced. When operating at high blow-up ratios, e.g. above 2:1 or above 2.5:1 or even above 3:1, the bubble stability of LLDPE materials according to the state of the art is poor. In contrast, the bubble stability in the production of films according to the present invention is good.

### EXAMPLES

The invention will now be illustrated by the following non-limiting examples.

### Example 1

Step 1: Preparation of the Catalyst

2.5 g of Sylopol 955 silica which had been dehydrated at 600° C. for 4 hours under a nitrogen flow was placed in a 40 cm³ flask. 15 cm³ of isopentane was added to slurry the silica, then 2.5 mmol of di-n-butyl magnesium was added to the flask, and the resultant mixture was stirred for 60 minutes at a temperature of 35° C. Then, 3.5 mmol of methyl n-propyl ketone was added to the flask, and the resultant mixture was stirred for 60 minutes at a temperature of 35° C. Then, 0.25 mmol of tetraethoxysilane was added to the flask and the resultant mixture was stirred for 30 minutes at a temperature of 35° C. Next, 0.25 mmol of titanium tetraethoxide was added to the flask and the resultant mixture was stirred for 30 minutes at a temperature of 35° C. Subsequently, 1.75 mmol of titanium tetrachlo ride was added to the flask and the resultant mixture was stirred for 30 minutes at a temperature of 35° C. Finally, the slurry was dried using a nitrogen purge at 70° C. for 60 minutes to field a free-flowing solid product.

Step 2: Polymerisation

The catalyst as produced in step 1 was used to produce linear low-density polyethylene in a fluidized bed gas phase polymerization reactor. The fluidized bed gas phase polymerization reactor had an internal diameter of 45 cm and was operated with a 140 cm zone height. The catalyst was fed to the reactor using a dry solid catalyst feeder to maintain a production rate of 10 kg per hour. Ethylene, 1-butene, hydrogen and nitrogen were introduced to the reactor to yield polymer with the required specifications. 5 wt % triethylaluminium (co-catalyst) solution in isopentane was continuously introduced to the reactor at a feed rate of 0.08 kg per hour. The reactor temperature was maintained at 86° C., ethylene partial pressure at 7.0 bar, total reactor pressure at 20.7 bar and superficial gas velocity at 0.42 m/s. The process ran for three consecutive days.

Step 3: Film Production

200 ppm of Irganox 1076 (2,6-di-tert-butyl-4-(octadecanoxycarbonylethyl)phenol, CAS registry number 2082-79-3), 500 ppm of zinc stearate and 800 ppm of Weston 399 (tris(nonylphenyl) phosphite, CAS registry number 26523-78-4) were added in a Henschel mixer and mixed for 5 minutes with 25 kg of the linear low-density polyethylene produced in step 2. The mixed material was pelletized using a ZSK-30 twin-screw extruder under the following conditions: a temperature profile of 130° to 210°, screw speed of 200 rpm, screw diameter of 30 mm, screw length to diameter ratio of 26, and an output of 20 kg per hour. The obtained pellets were converted to a blown film of 25 μm thickness using a Battenfeld machine under the following conditions: a temperature profile of 190° C. to 200° C., a screw speed of 60 rpm, a screw diameter of 60 mm, screw length to diameter ratio of 27, a die gap of 2.3 mm, a frost line height of 40 cm, a blow-up ratio of 2.5:1, and an output rate of 58 kg per hour.

### Example A (Comparative)

A sample of a commercially available LLDPE grade was used. This grade is produced using a conventional Ziegler-Natta catalyst, using 1-butene as comonomer. Pellets of the LLDPE material were converted to a blown film of 25 μm thickness using a Battenfeld machine under the following conditions: a temperature profile of 190° C. to 200° C., a screw speed of 60 rpm, a screw diameter of 60 mm, screw length to diameter ratio of 27, a die gap of 2.3 mm, a frost line height of 40 cm, a blow-up ratio of 2.5:1, and an output rate of 58 kg per hour.

The properties of the LLDPE materials and films produced as described above are presented in table 1 below.

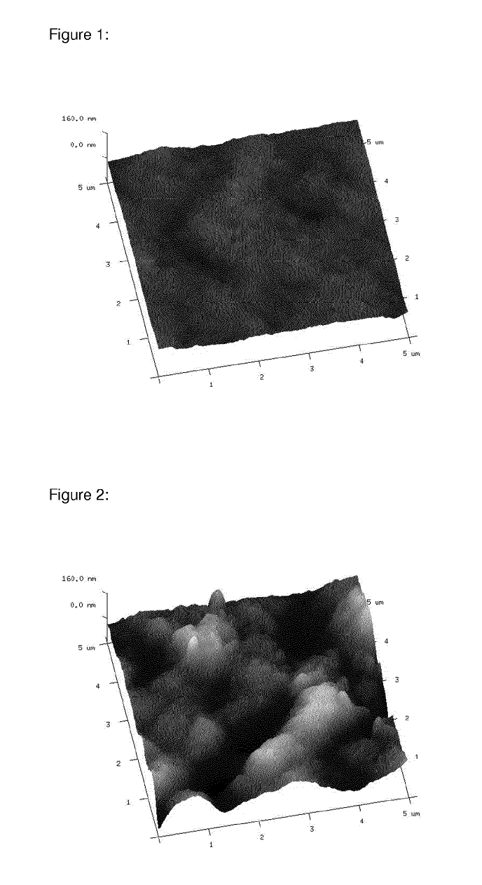

Samples of materials from examples 1 and A were subjected to topography imaging by AFM. A method for topography imaging by AFM is for example described in Atomic Force Microscopy, V. Bellitto (ed), InTech, 2012, p. 147-174. The resulting images are presented in FIG. 1 (example 1) and FIG. 2 (example A).

TABLE 1

| | | | Example A |
|---|---|---|---|
| | Test method | Example 1 | (comparative) |
| Density (kg/m³) | ASTM D-792 | 918 | 921 |
| Melt Index 2.16 kg/ | ASTM D-1238 | 1.94 | 1.89 |
| 190° C. (g/10 min) | | | |
| Melt Index 21.6 kg/ | ASTM D-1238 | 56.8 | 45.8 |
| 190° C. (g/10 min) | | | |
| Melt Flow Rate | ASTM D-1238 | 29.4 | 24.2 |
| Mn (g/mole) | ASTM D-6474 99 | 27179 | 28903 |
| Mw (g/mole) | ASTM D-6474 99 | 113715 | 115343 |
| MWD (g/mole) | ASTM D-6474 99 | 4.18 | 3.99 |
| Mz (g/mole) | ASTM D-6474 99 | 351880 | 327421 |
| Mz + 1 (g/mole) | ASTM D-6474 99 | 788744 | 735037 |
| 1% Secant modulus | ASTM D-882 | 167.1/191.7 | 166.2/169.6 |
| MD/TD (MPa) | | | |
| Tear resistance | ASTM D-1922 | 4.8/16.3 | 5.2/15.4 |
| MD/TD (g/mic) | | | |
| Tensile strength | ASTM D-882 | 9.9/10.2 | 9.8/10.6 |
| at yield MD/TD | | | |
| (MPa) | | | |
| Tensile strength | ASTM D-882 | 33.3/28.1 | 36.0/31.7 |
| at break MD/TD | | | |
| (MPa) | | | |
| Tensile elongation | ASTM D-882 | 53.8/14.1 | 65.7/13.8 |
| at yield MD/TD | | | |
| (%) | | | |
| Tensile elongation | ASTM D-882 | 645/830 | 690/856 |
| at break MD/TD | | | |
| (%) | | | |
| Clarity (%) | ASTM D-1746 97 | 98.7 | 95.9 |
| Haze (%) | ASTM D-1003 | 7.96 | 20.87 |
| RMS roughness | ISO 4287 1997 | 12.0 | 45.0 |
| 5 μm (nm) | | | |
| Average roughness | ISO 4287 1997 | 6.5 | 34.4 |
| 5 μm (nm) | | | |

ASTM D-792 relates to a standard test method for density and specific gravity (relative density) of plastics by displacement.

ASTM D-1238 relates to a standard test method for melt flow rates of thermoplastics by extrusion plastometer.

ASTM D-6474 99 relates to a standard test method for determining molecular weight distribution and molecular weight averages of polyolefins by high temperature gel permeation chromatography.

ASTM D-882 relates to a standard test method for tensile properties of thin plastic sheeting.

ASTM D-1922 relates to a standard test method for propagation tear resistance of plastic film and thin sheeting by pendulum method

ASTM D-1746 97 relates to a standard test method for transparency of plastic sheeting.

ASTM D-1003 relates to a standard test method for haze and luminous transmittance of transparent plastics

ISO 4287:1997 relates to geometrical product specifications- Surface texture: Profile method. The data regarding RMS roughness and average roughness given in Table 1 as well as the images FIG. 1 and FIG. 2 were obtained in tapping mode by AFM using A Bruker Dimension Edge AFM. Measurements were done on the primary profile with the Bruker Nanoscope V6.14 software. One dimensional bow removal was applied prior to measurements. Scan rate was 1 Hz with 256 data points per line. Image size 5 μm by 5 μm. An OTESPA-R3 silicon probe with the following characteristics was used: cantilever thickness 3.7 μm, cantilever length 160 μm, cantilever width 40 μm; spring constant (k): 26 N/m; resonance frequency (f₀): 300 kHz. For RMS roughness and/or average roughness measurements sampling length was 5 μm.

The AFM topographic images, obtained in tapping mode, as presented in FIG. 1 (relating to example 1) and FIG. 2 (relating to comparative example A) show that the surface structure of the material of example 1 is clearly different from the surface structure of the material according to comparative example A, in that the image of the material of comparative example A shows for example a globular morphology having significantly larger globules than is the case for the image of the material of example 1.

1. A film for use in plasticulture, comprising at least a first layer of a thermoplastic polymer composition, said thermoplastic polymer composition comprising a linear low-density polyethylene having a melt index measured according to ASTM D1238 at a temperature of 190° C. and a load of 2.16 kg of higher than 1.0 g/10 min and at most 10.0 g/10 min, whereby the film has an RMS roughness measured by AFM according to point 4.2.2 of ISO 4287:1997of lower than 40 nm, and/or an average roughness measured by AFM according to point 4.2.1 of ISO 4287:1997 of lower than 30 nm.

2. The film according to claim 1 in which said linear low-density polyethylene is obtained by a process for producing a copolymer of ethylene and an second α-olefin comonomer in the presence of an Advanced Ziegler-Natta catalyst, wherein the Advanced Ziegler-Natta catalyst is produced in a process comprising the steps of:
(a) contacting a dehydrated support having hydroxyl groups with a magnesium compound having the general formula MgR¹R², wherein R¹ and R² are the same or different and are independently an alkyl group, alkenyl group, alkadienyl group, aryl group, alkaryl group, alkenylaryl group or alkadienylaryl group;
(b) contacting the product obtained in step (a) with modifying compounds (A), (B) and (C), wherein:compound (A) is at least one of carboxylic acid, carboxylic acid ester, ketone, acyl halide, aldehyde or alcohol;
compound (B) is a compound having the general formula R¹¹_{f}(R¹²O)_{g}SiXₕ, wherein f, g and h are each integers from 0 to 4 and the sum of f, g and h is equal to 4, Si is a silicon atom, O is an oxygen atom, X is a halide atom and R¹¹ and R¹² are the same or different and are independently an alkyl group, alkenyl group, alkadienyl group, aryl group, alkaryl group, alkenylaryl group or alkadienylaryl group, with a proviso that when h is equal to 4 then modifying compound (A) is not an alcohol;
compound (C) is a compound having the general formula (R¹³O)₄M, wherein M is a titanium atom, a zirconium atom or a vanadium atom, O is an oxygen atom and R¹³ is an alkyl group, alkenyl group, alkadienyl group, aryl group, alkaryl group, alkenylaryl group or alkadienylaryl group; and
(c) contacting the product obtained in step (b) with a titanium halide compound having the general formula TiX₄, wherein Ti is a titanium atom and X is a halide atom.

3. The film according to claim 2, wherein the second α-olefin comonomer is propylene, 1-butene, 1-pentene, 1-hexene, 1-octene, 4-methyl-1-pentene, 1,3-butadiene, 1,4-pentadiene, 1,5-hexadiene or mixtures thereof.

4. The film according to claim 2, wherein said support for said Advanced Ziegler Natta catalyst is silica, alumina, magnesia, thoria, zirconia or mixtures thereof.

5. The film according to claim 2, wherein compound (A) is methyl-n-propyl ketone, ethyl acetate, n-butyl acetate, acetic acid, isobutyric acid, isobutyraldehyde, ethanoyl chloride, ethanol or sec-butanol.

6. The film according to claim 2, wherein compound (B) is tetraethoxysilane, n-propyltriethoxysilane, isobutyltrimethoxysilane, dimethyldichlorosilane, n-butyltrichlorosilane or silicon tetrachloride.

7. The film according to claim 2, wherein compound (C) is titanium tetraethoxide, titanium tetra-n-butoxide or zirconium tetra-n-butoxide.

8. The film according to claim 2, wherein TiX₄ is TiCl₄.

9. The file according to claim 1, wherein said thermoplastic polymer composition further comprises radiation absorbing additives, in which said absorbing additives are NIR absorbing additives and/or UV absorbing additives.

10. The film according to claim 1, wherein said thermoplastic polymer composition comprises a NIR absorbing additive or an UV absorbing additive.

11. The film according to claim 10, in which said NIR absorbing additive is an organic NIR absorbers or inorganic NIR absorbers, or combinations thereof.

12. The film according to any of the claims 1 to 11, wherein the film is made with a temperature profile of 100° C. to 300° C. and/or a die gap of 0.1 mm to 7 mm and/or a frost line height of 10 cm to 90 cm and/or a blow-up ratio of 1.2:1 to 5:1.

13. The film according to claim 10, in which said UV absorbing additive is a benzophenones, benzotriazole, salicylates, or combinations thereof.

14. The film according to claim 1 wherein the film is an agricultural film.

15. A greenhouse cover comprising a film according to claim 1.

16. The film according to claim 2, wherein
compound (A) is methyl-n-propyl ketone, ethyl acetate, n-butyl acetate, acetic acid, isobutyric acid, isobutyraldehyde, ethanoyl chloride, ethanol or sec-butanol;
compound (B) is tetraethoxysilane, n-propyltriethoxysilane, isobutyltrimethoxysilane, dimethyldichlorosilane, n-butyltrichlorosilane or silicon tetrachloride; and
compound (C) is titanium tetraethoxide, titanium tetra-n-butoxide or zirconium tetra-n-butoxide.

17. The film according to claim 16, wherein said thermoplastic polymer composition further comprises radiation absorbing additives, in which said absorbing additives are NIR absorbing additives and/or UV absorbing additives.

18. The film according to claim 17, wherein said thermoplastic polymer composition comprises a NIR absorbing additive.

19. The film according to claim 19, in which said UV absorbing additive is a benzophenone, benzotriazole, salicylate, or combinations thereof.

20. A greenhouse cover comprising a film according to 19.
